(19) United States
(12) Patent Application Publication
(10) Pub. No.: US 2011/0083399 A1
(43) Pub. Date: Apr. 14, 2011

(54) STRUCTURES AND METHODS FOR MOUNTING AN OBJECT

(75) Inventors: David Lettkeman, Parker, CO (US); Kevin S. Holle, Parker, CO (US)

(73) Assignee: DISH NETWORK L.L.C., Englewood, CO (US)

(21) Appl. No.: 12/578,367

(22) Filed: Oct. 13, 2009

(51) Int. Cl. H01Q 1/22; E04B 1/38

(52) U.S. Cl. 52/745.21; 248/219.4; 248/219.1

(57) ABSTRACT

An apparatus for mounting an object to pole is presented. The apparatus includes an elongate planar section defining a longitudinal direction. The apparatus further includes two extension sections, wherein each extension section extends from an elongate edge of the planar section in a direction perpendicular to the elongate planar section. Each of the extension sections defines a cutout area centered along a longitudinal edge of the extension section, wherein the cutout area is configured to contact a pole. The planar section also defines a plurality holes to be used for affixing the apparatus to the pole and to attach the object to the apparatus.

### BACKGROUND

With the introduction of direct-to-home satellite broadcast television systems, such as Direct Broadcast Satellite (DBS) systems, a multitude of television programs, audio channels, and the like previously unknown with terrestrial (“over-the-air”) broadcast systems was made accessible to millions of potential subscribers. One aspect of such systems that allows such wide accessibility is the use of a small (e.g., less than one meter in diameter) and inexpensive satellite antenna, or “dish”. To effectively employ such an antenna, a subscriber merely provides direct line-of-sight between the dish and the satellites of interest, and supplies a stable mounting platform or base to which the antenna is mounted, such as the exterior of the subscriber's home. The latter requirement helps prevent the antenna from becoming misaligned or misdirected as the result of strong winds or other meteorological conditions, which may cause disruption of the satellite signal carrying the programming.

In many cases, a subscriber may determine that a pole or similarly-configured structure conveniently located in the vicinity of the proposed location for the receiver is desirable as a mounting base for the antenna. While such a pole may provide an extremely stable structure to which an antenna may be mounted, the subscriber may desire to attach the antenna thereto without drilling holes in the pole, or otherwise inflicting significant damage on the pole. Further, the diameter of each pole potentially utilized as an antenna mounting base may vary widely from one subscriber premises to another, thus rendering the ability to provide a single attachment structure for mounting an antenna to such a pole problematic.

### BRIEF DESCRIPTION OF THE DRAWINGS

Many aspects of the present disclosure may be better understood with reference to the following drawings. The components in the drawings are not necessarily depicted to scale, as emphasis is instead placed upon clear illustration of the principles of the disclosure. Moreover, in the drawings, like reference numerals designate corresponding parts throughout the several views. Also, while several embodiments are described in connection with these drawings, the disclosure is not limited to the embodiments disclosed herein. On the contrary, the intent is to cover all alternatives, modifications, and equivalents.

FIGS. 1A and 1B are perspective views of opposing sides of a plate for attaching an object to a pole according to an embodiment of the invention.

FIG. 2 is a top view of a cutout area of an extension section of the plate of FIG. 1 according to an embodiment of the invention.

FIG. 3 is a perspective view of two of the plates of FIG. 1 attached to a pole according to an embodiment of the invention.

FIG. 4 is a perspective view of an antenna mast footing that is attached to the plates shown in FIG. 3 according to an embodiment of the invention.

FIG. 5 is a flow diagram of a method according to an embodiment of the invention of mounting an object to a pole.

### DETAILED DESCRIPTION

The enclosed drawings and the following description depict specific embodiments of the invention to teach those skilled in the art how to make and use the best mode of the invention. For the purpose of teaching inventive principles, some conventional aspects have been simplified or omitted. Those skilled in the art will appreciate variations of these embodiments that fall within the scope of the invention. Those skilled in the art will also appreciate that the features described below can be combined in various ways to form multiple embodiments of the invention. As a result, the invention is not limited to the specific embodiments described below, but only by the claims and their equivalents.

In addition, directional references employed below, such as “up”, “down”, “left”, “right”, “back”, “front”, “upper”, “lower”, and so on, are provided to relate various aspects of the structures to each other, and are not intended to limit the embodiments disclosed herein to a particular orientation with respect to their surrounding environment.

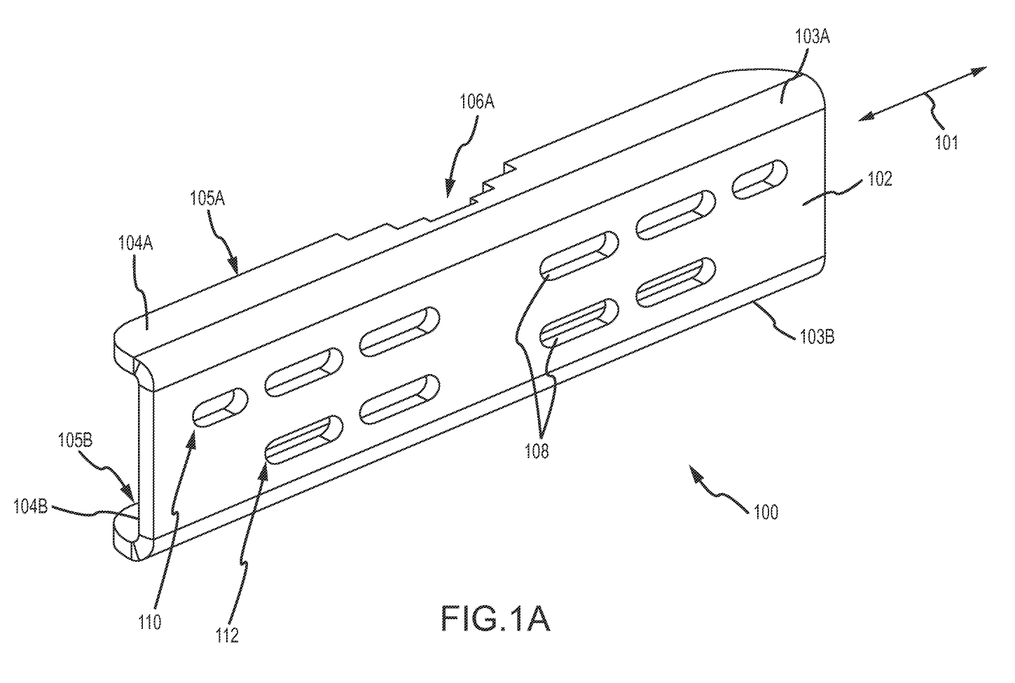

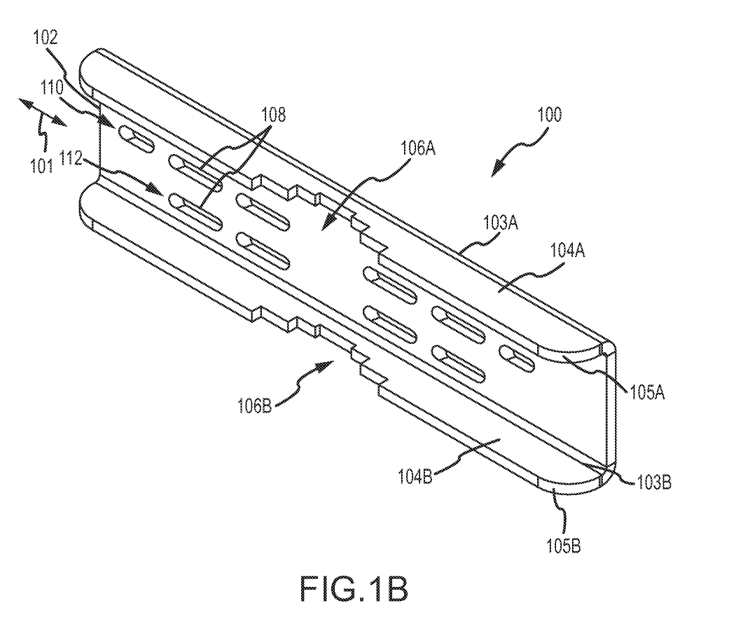

FIGS. 1A and 1B depict an apparatus 100 (hereinafter termed a “plate” 100) for attaching an object to a pole according to one embodiment of the invention. More specifically, FIG. 1A provides a perspective view of one side of the plate 100, while FIG. 1B provides a perspective view of the reverse side. As referenced in the description below, a pole may be any linearly-fashioned structure to which an object may be attached. While longitudinal axes of most poles are considered to be oriented vertically, poles or similar structures that may be oriented horizontally or in other directions may be employed in further implementations of the invention. Also, the pole may be made of any suitable material, including, but not limited to, steel, aluminum, wood, plastic, fiberglass, and various composite materials. Further, while most poles are cylindrical in cross-section, others cross-sectional shapes, such as square or rectangular, may also be employed in conjunction with the embodiments discussed below.

The plate 100 of FIGS. 1A and 1B includes an elongate planar section 102 having a longitudinal direction 101. The elongate planar section 102 includes a first elongate edge 103A and a second elongate edge 103B. The elongate edges 103 are opposing edges of the elongate planar section 102 and are aligned along the longitudinal direction 101.

The elongate planar section 102 defines a number of holes 108 that may be used to affix the plate 102 to a pole, and to attach an object to the plate 100. In the particular embodiment of FIGS. 1A and 1B, the holes 108 are arranged into two rows 110, 112 aligned in the longitudinal direction 101. Also in this embodiment, the holes 108 are elongated in the shape of slots along the same longitudinal direction 101 to allow some positioning adjustment in the connection of the plate 100 to the pole and the object. However, other shapes and orientations of the holes 108 may be utilized in other implementations. More details pertaining to the holes 108 are provided below.

The plate 100 also includes a first extension section 104A and a second extension section 104B coupled to the elongate planar section 102. More specifically, the first extension section 104A is aligned along the longitudinal direction 101 and extends from the first elongate edge 103A in a direction perpendicular to the elongate planar section 102. Similarly, the second extension section 104B extends from the second elongate edge 103B in the same direction as the first extension section 104A.

In addition, the first extension section 104A defines a first cutout area 106A centered along a longitudinal edge 105A of the first extension section 104A opposite the first elongate edge 103A. Correspondingly, the second extension section 104B defines a second cutout area 106A centered along a longitudinal edge 105B of the second extension section 104B opposite the second elongate edge 103B. As described in greater detail below, the cutout areas 106 are adapted to engage or make contact with a pole to be utilized for mounting an object.

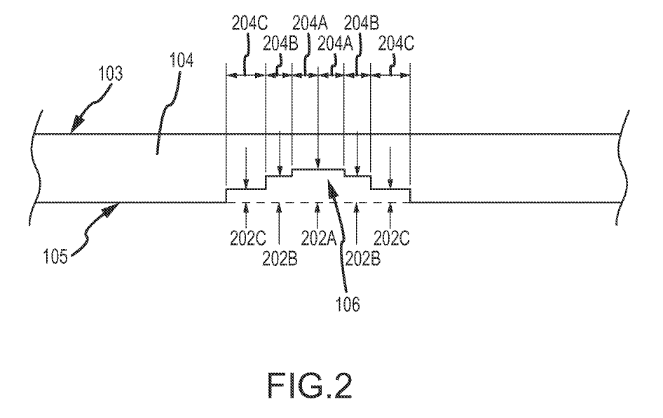

A plan view of one of the extension sections 104 focusing on the cutout area 106 is shown in FIG. 2. In this embodiment, the cutout area 106 forms a stepped pattern possessing multiple discrete depths 202A, 202B, 202C from the longitudinal edge 105 of the extension section 104 toward the elongate edge 103. The stepped pattern also exhibits discrete widths 204A, 204B, 204C for each step. In the particular embodiment of FIG. 2, the stepped pattern is deeper at the center of the cutout area 106 (depth 202A) than at the ends of the pattern (depth 202C). Such a pattern allows the cutout area 106 to contact at least two points of different poles of varying diameters. In some implementations, the depth 202 and width 204 of each step may vary from the center to the end of the cutout area 106 to more closely accommodate varying pole diameters. For example, the widths 204 and the depths 202 of the steps may progressively increase when proceeding from the center to either end of the cutout area 106. Such a stepped pattern may allow the cutout area 106 to more closely match the circumference of poles of various diameters.

In another implementation, the widths 204 of the steps may be configured to closely fit various sizes of poles of square or rectangular cross-section. As shown in FIG. 2, for example, the widths 204A of the center step (i.e., 2×204A) may match a relatively small square pole (e.g., one inch in diameter). Further, the widths associated with the next shallowest depth 202B (i.e., 2×(204A+204B)) may mate with a larger square pole two inches across, while the widths for the shallowest depth 202C (i.e., 2×(204A+204B+204C)) may match a square pole of three inches in diameter. Other step widths 204 may be utilized in other arrangements.

While FIG. 2 specifically shows a pattern of three different depths 202 for the steps, more or fewer numbers of different depths 202 may be utilized in other configurations. In fact, other patterns for the cutout area 106, including those using smoother or more ragged edges, or no edges at all, may be employed in other implementations.

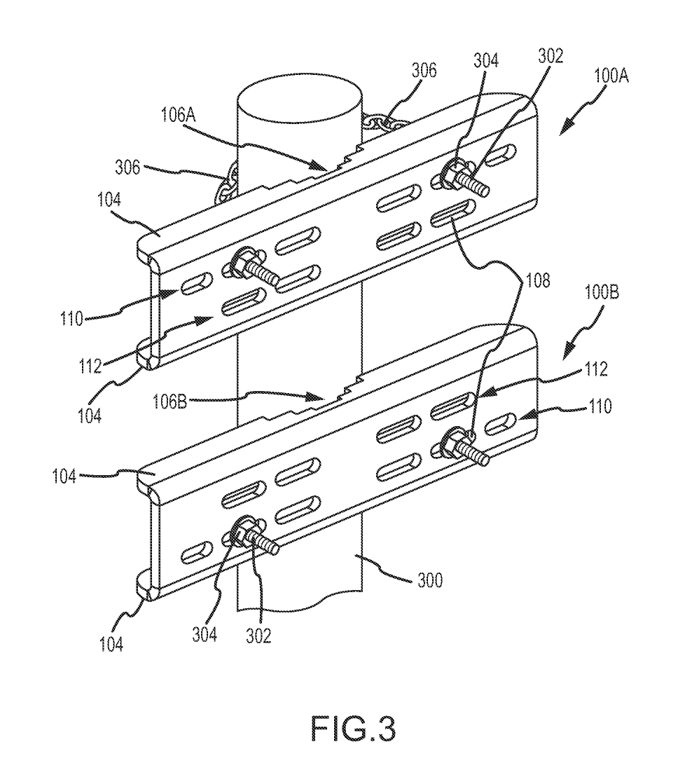

FIG. 3 provides a perspective view of two plates 100A, 100B similar or identical to plate 100 of FIG. 1 attached to a pole 300. In this implementation, the plates 100A, 100B are to be used to attach a mast footing for a satellite antenna to the pole 300. One example of such an antenna may be a small dish antenna often employed by satellite television service subscribers to receive multiple channels of television programming from a satellite in geosynchronous orbit. Other types of antennas, such as terrestrial antennas for other types of communication, may be attached to the pole 300 in other implementations. Further, virtually any type of device or object may be securely affixed to a pole by employing the various structures and concepts presented herein.

In one example, the plates 100A, 100B may be about fourteen inches in length (left-to-right in FIG. 3), and about two-to-three inches in width (top-to-bottom in FIG. 3). The pole 300 may be about seven inches wide. Differing dimensions, either smaller or larger, for both the pole 300 and the plates 100A, 100B may be involved in other implementations. Additionally in one embodiment, the plates 100A, 100B may be fabricated from sheet metal or another material of sufficient strength to resist flexing and deformation, especially under inclement weather conditions, such as strong winds, heavy rains, and the like. In that case, the sheet metal may be bent or folded to produce extension sections 104 of the plates 100. Other materials, such as plastic, fiberglass, wood, or composite materials, may be employed in other implementations. Also, the plates 100A, 100B may be approximately one-eighth to one-sixteen inch thickness, although any other thickness may be utilized so that the plates 100A, 100B are fashioned to withstand the gravitational and external forces expected in the environment in which the object will be mounted.

In one embodiment, the first plate 100A is positioned at a desirable location along the length of the pole 300, centered on the pole 300 so that the cutout area 106A contacts the center of the pole 300, and attached thereto. This configuration results in the plate 100A being oriented perpendicular to the length of the pole 300. In this example, bolt connectors 302, such as eyebolts, may be passed through separate holes 108 of the plate 100A and attached to the first plate 100A by way of nuts 304 and washers. Other types of fasteners other than eyebolts 302, nuts 304, washers, and the like may be utilized in other embodiments. In one example, the holes 108 closest to the center of the plate 102A that allow the eyebolts 302 to pass through the holes 108 without interfering with the pole 300 are selected for the eyebolts 302. Also in this example, the first row 110 of holes 108 (i.e., the row 110 with more holes 108) is selected as the row to be used to affix the first plate 100A to the pole 300 since the first row 110 includes additional holes 108 toward the ends of the first plate 100A, resulting in a longer first row 110 to allow the first plate 100A to be attached to exceptionally wide poles 300.

An elongate medium, such as a length of chain 306, may then be passed around the pole 300 and attached to the eyebolts 302 so that the pole 300 is located between the chain 306 and the first plate 100A. The nuts 304 on the eyebolts 302 may then be tightened to clamp or compress the pole 300 securely between the chain 306 and the first plate 100A. In this example, the first cutout 106A, with its 90-degree angles formed by a stepped pattern, helps maintain the original orientation of the first plate 100A about the pole 300. In other embodiments, other types of flexible or semi-flexible material, such as stainless steel banding or heavy-duty fabric, may be used instead of the chain 300 as the elongate medium.

In one arrangement, a detachable link (not shown in FIG. 3), such as a “quick” link, carabiner, or the like, may be used to adjust the chain 306 to more closely fit the pole 300 and the first plate 100A by linking one of the intermediate links of the chain to one of the eyebolts 302 by way of the adjustable link.

Also depicted in FIG. 3, the second plate 100B is attached to the pole 300 in a fashion similar to that for the first plate 100A, as discussed above. The second plate 100B is positioned on the same side of the pole 300 as the first plate 100A so that the two plates 100A, 100B are parallel to each other, thus providing a planar surface to which an object may be attached. The second plate 100B is attached to the pole 300 using two holes 108 the first row 110, as was done with the first plate 100A.

In the particular example of FIG. 3, the second plate 100B is inverted compared to the first plate 100A so that the first row 110 of holes 108 is located below the second row 112 of holes 108. This orientation allows an object to be attached to the pole 300 using the second row 112 of holes 108 of each of the plates 100A, 100B. Further, the distance between the first plate 100A and the second plate 100B along the pole 300 may be adjusted so that the second rows 112 of holes 108 are spaced an acceptable distance apart to allow the object of interest to be attached to the plates 100A, 100B.

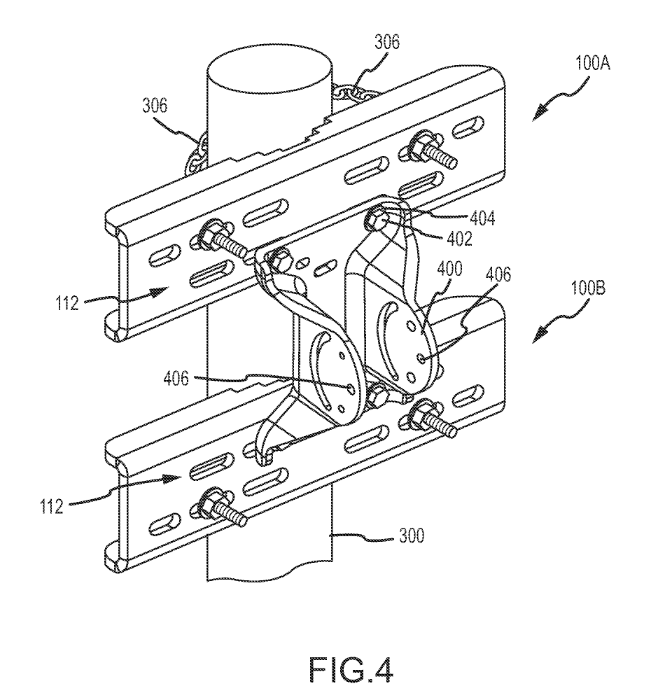

FIG. 4 illustrates the assembly of FIG. 3, with the addition of a mast footing 400 to be used for holding a mast (not shown in FIG. 4) to which an antenna (also not shown in FIG. 4) is then to be attached. In the example of FIG. 4, the footing 400 is bolted to holes 108 in the second row 112 of both of the plates 100A, 100B using bolts 402 and washers 404, possibly with threaded nuts (not shown in FIG. 4) on the opposing side of the plates 100A, 100B. Other components for securing the footing 400 to the plates 100A, 100B, such as screws, locking nuts, serrated hex head nuts, nuts integrated with lock washers, clips, clamps, and the like, may be utilized in other embodiments to attach the footing 400 to the plates 100A, 100B, or the plates 100A, 100B to the pole 300.

As a result of attaching the footing 400 to the plates 100A, 100B, the footing 400 is aligned vertically, and thus parallel to the pole 300. An end of a mast attached to the footing 400 by way of holes 406 defined therein will allow the mast to pivot in a vertical plane, thus allowing vertical adjustment of a satellite antenna attached to an opposing end of the mast. In other situations, other objects requiring a vertical planar surface for attachment may employ the pole 300 and plates 100A, 100B as assembled in FIG. 3.

While a vertically-oriented pole 300 is employed in FIGS. 3 and 4, horizontally-oriented poles and pole-like structures, such as fences and railings, may be used as structures to which one or more plates 100 may be affixed to provide an attachment base for an object. Additionally, one or more plates 100 may be attached to poles of any type of orientation other than strictly horizontal or vertical for connection of objects or devices to such poles in other embodiments.

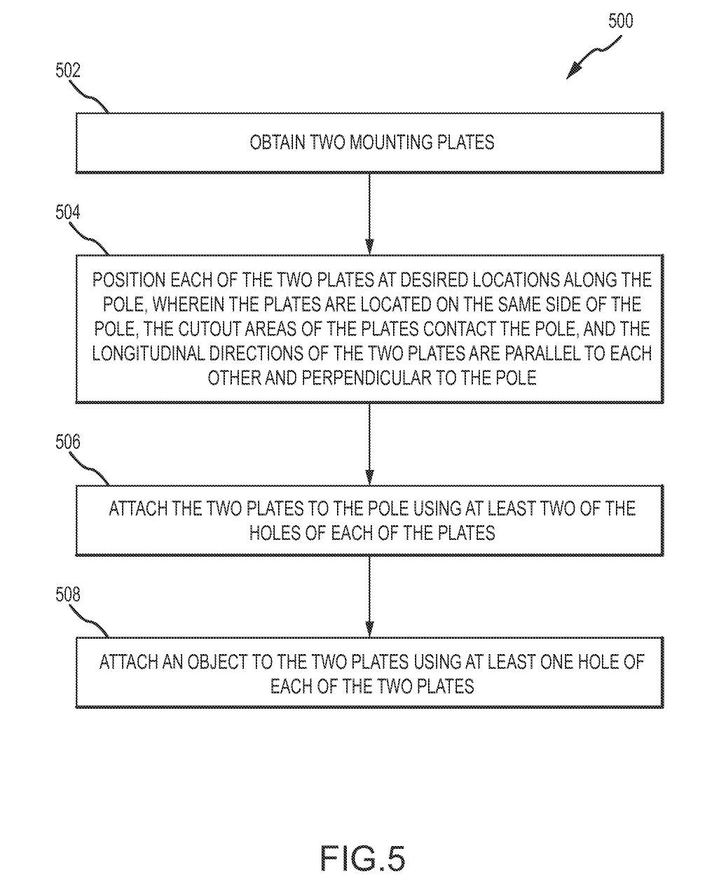

FIG. 5 provides a flow diagram describing a method 500 of connecting an object to a pole. In the method 500, two mounting plates, such as the plates 100A, 100B described above in conjunction with FIGS. 3 and 4, are obtained (operation 502). The plates are then positioned at desired locations along the pole (operation 504). More specifically, the plates are placed on the same side of the pole, with the cutout areas of the plates being placed in contact with the pole, and the longitudinal directions of the plates parallel to each other and perpendicular to the length of the pole.

The two plates are then attached to the pole using at least two of the holes of each of the plates (operation 506), as shown in FIG. 3. For example, opposing ends of a chain, strap, belt, or similar device may be attached to a plate to hold the pole between the device and the plate, as described above. Thereafter, an object of interest may then be attached to the two plates using at least one hole of each of the plates (operation 508). In some embodiments, the attachment of the plates to the pole, and of the object to the plates, may be performed as described above with respect to FIGS. 3 and 4.

While much of the above discussion focuses on the use of two plates, such as the plates 100A, 100B described above, other numbers of plates may be employed in other arrangements. For example, smaller objects, or those objects requiring less support, may employ only a single plate 100 to attach to a pole. Oppositely, larger or more unwieldy objects may benefit from the user of three or more plates 100 affixed to the pole.

Various embodiments as described herein may provide a number of benefits. Generally, the apparatus and methods disclosed above allow the secure and stable installation of any object, such as a footing and attached antenna, to a pole or pole-like structure of any orientation without inflicting significant damage, such as drilled holes, to the pole. In the specific case of a satellite television subscriber, this ability to mount an antenna in such a manner allows a subscriber to utilize preexisting poles or pole-like structures for such a purpose. Further, the use of two separate plates in some embodiments facilitates a relatively lightweight solution while providing a structural platform strong enough to hold the antenna or other object securely in the presence of strong winds or other deleterious environmental conditions. Further, in two-plate arrangements, by employing multiple holes, slotted holes, and the like, and adjusting the distance between the two plates, a single version of the apparatus may allow connection of a wide variety of objects, such as mast footings of various sizes, to be secured mounted.

While several embodiments of the invention have been discussed herein, other embodiments encompassed by the scope of the invention are possible. For example, while various embodiments have been described primarily within the context of satellite and terrestrial antenna systems and similar equipment, any object requiring a stable platform, including signage, lighting, and so on, may benefit from the implementation of the principles described herein, with respect to both outdoor and indoor applications. In addition, aspects of one embodiment disclosed herein may be combined with those of alternative embodiments to create further implementations of the present invention. Thus, while the present invention has been described in the context of specific embodiments, such descriptions are provided for illustration and not limitation. Accordingly, the proper scope of the present invention is delimited only by the following claims and their equivalents.

What is claimed is:

1. An apparatus for mounting an object to a pole, comprising:
an elongate planar section defining a longitudinal direction and comprising a first elongate edge and a second elongate edge, wherein the first and second elongate edges are aligned along the longitudinal direction and are opposite one another; and
first and second extension sections aligned along the longitudinal direction, wherein the first extension section extends from the first elongate edge in a direction perpendicular to the elongate planar section, and wherein the second extension section extends from the second elongate edge in the same direction as the first extension section;
wherein the first extension section defines a first cutout area centered along a longitudinal edge of the first extension section opposite the first elongate edge, wherein the second extension section defines a second cutout area centered along a longitudinal edge of the second extension section opposite the second elongate edge, and wherein the first cutout area and the second cutout area are configured to contact the pole; and
wherein the elongate planar section defines a plurality of holes employable to affix the apparatus to the pole and to attach the object to the apparatus.

2. The apparatus of claim 1, wherein each of the first cutout area and the second cutout area is configured to contact a minimum of two points on the pole.

3. The apparatus of claim 1, wherein each of the first cutout area and the second cutout area comprises a stepped pattern having multiple discrete depths from the longitudinal edge of the associated extension section toward the associated elongate edge, wherein the depth of the stepped pattern toward ends of the cutout area is less than the depth of the stepped pattern at a center of the cutout area.

4. The apparatus of claim 3, wherein each of the first cutout area and the second cutout area comprises at least three different depths of the stepped pattern.

5. The apparatus of claim 3, wherein the stepped pattern of each of the first cutout area and the second cutout area is configured to fit the pole, wherein the pole comprises rectangular tubing.

6. The apparatus of claim 1, wherein at least one of the holes comprises an elongate slot aligned along the longitudinal direction.

7. The apparatus of claim 1, wherein the holes are aligned in at least a first row and a second row, wherein the first row and the second row are parallel to each other and extend along the longitudinal direction.

8. The apparatus of claim 7, wherein the first row includes more holes than the second row, and wherein the first row is longer than the second row.

9. The apparatus of claim 7, wherein the holes of the first row are configured to receive bolts for attaching the apparatus to the pole, and wherein the holes of the second row are configured to attach the object to the apparatus.

10. The apparatus of claim 1, wherein the holes are configured to attach a mast footing for a satellite communication antenna.

11. The apparatus of claim 1, wherein the apparatus is fashioned from a single section of sheet metal folded to form the first and second extension sections.

12. A mounting kit for attaching an object to a pole, the kit comprising:
two plates, wherein each of the two plates comprises:
an elongate planar section defining a longitudinal direction and comprising a first elongate edge and a second elongate edge, wherein the first and second elongate edges are aligned along the longitudinal direction and are opposite one another; and
first and second extension sections aligned along the longitudinal direction, wherein the first extension section extends from the first elongate edge in a direction perpendicular to the elongate planar section, and wherein the second extension section extends from the second elongate edge in the same direction as the first extension section;
wherein the first extension section defines a first cutout area centered along a longitudinal edge of the first extension section opposite the first elongate edge, wherein the second extension section defines a second cutout area centered along a longitudinal edge of the second extension section opposite the second elongate edge, and wherein the first cutout area and the second cutout area are configured to contact the pole; and
wherein the elongate planar section defines a plurality of holes employable to affix the plate to the pole and to attach the object to the plate; and
a plurality of attachment mechanisms configured to affix each of the two plates to the pole.

13. The kit of claim 12, wherein at least one of the attachment mechanisms comprises:
a length of chain; and
two bolt connectors, wherein each of the bolt connectors is configured to couple the length of chain to one of the holes of one of the plates.

14. The kit of claim 13, wherein the at least one of the attachment mechanisms further comprises:
a detachable link configured to couple the length of chain to one of the bolt connectors.

15. The kit of claim 11, further comprising:
a footing configured to be attached to at least one of the holes of each of the plates, and to receive a mast for a satellite communication antenna.

16. A method of mounting an object to a pole, the method comprising:
obtaining two plates, wherein each plate comprises:
an elongate planar section defining a longitudinal direction and comprising a first elongate edge and a second elongate edge, wherein the first and second elongate edges are aligned along the longitudinal direction and are opposite one another; and
first and second extension sections aligned along the longitudinal direction, wherein the first extension section extends from the first elongate edge in a direction perpendicular to the elongate planar section, and wherein the second extension section extends from the second elongate edge in the same direction as the first extension section;
wherein the first extension section defines a first cutout area centered along a longitudinal edge of the first extension section opposite the first elongate edge, wherein the second extension section defines a second cutout area centered along a longitudinal edge of the second extension section opposite the second elongate edge, and wherein the first cutout area and the second cutout area are configured to contact the pole; and
wherein the elongate planar section defines a plurality of holes employable to affix the plate to the pole and to attach the object to the plate;
positioning each of the two plates at desired locations along the pole, wherein the two plates are located on the same side of the pole, wherein the first and second cutout areas of each of the two plates contacts the pole, and wherein the longitudinal directions of the two plates are aligned parallel to each other and perpendicular to a length of the pole;
attaching the two plates to the pole using at least two of the holes of each of the two plates; and
attaching the object to the two plates using at least one hole of each of the two plates.

17. The method of claim 16, wherein attaching each of the two plates to the pole comprises, for each of the two plates:
wrapping an elongate medium around a side of the pole opposite the associated plate;
attaching the elongate medium to the at least two of the holes of the associated plate; and
tightening the elongate medium to securely affix the associated plate to the pole.

18. The method of claim 17, wherein the elongate medium comprises one of a chain, a steel strap, and a fabric belt.

19. The method of claim 16, wherein positioning each of the two plates comprises:
locating one of the two plates at a first desired location along the pole; and
positioning another of the two plates along the pole relative to the one of the two plates so that the two plates are positioned so that the object is attachable to both of the two plates via the at least one of the holes of each of the two plates.

20. The method of claim 19, wherein attaching the object to each of the two plates comprises:
bolting the object to the two plates via the at least one of the holes in each of the two plates.
